(19) United States
(12) Patent Application Publication
(10) Pub. No.: US 2005/0108504 A1
(43) Pub. Date: May 19, 2005

(54) Behavior agent based system and process for machine to machine applications and services

(76) Inventors: Gregory Lynn Cowin, Frisco, TX (US); Byron Kirk Appelt, Grand Prairie, TX (US); Jeffrey O. Smith, Dallas, TX (US)

Correspondence Address: Robert C. Klinger;Jackson Walker LLP, Suite 600, 2435 North Central Expressway, Richardson, TX, 75080, US

(21) Appl. No.: 10/969,286

(22) Filed: Oct. 20, 2004

Related U.S. Application Data
(60) Provisional application No. 60/512,668, filed on Oct. 20, 2003.

(51) Int. Cl. G06F 15/00

(52) U.S. Cl. 712/32

(57) ABSTRACT

The present invention comprises a Behavior (201) based M2M platform having a combination of hardware and software that connects an active global network of devices, sensors, and actuators. The present invention uses Behavior (201) composition, transmission and sequencing to avoid the need for direct programming. The Behavior (201) concept refers to the use of at least one stimulus-response pair. A self-contained message is an example of a stimulus (such as a telemetry reading, alarm and the like), for a Behavior (201) created by a user, such as an end-user.

### CROSS REFERENCE TO RELATED APPLICATION

This application is related to U.S. Provisional Patent Application No. 60/512,668, filed on Oct. 20, 2003, entitled “Behavior Based Architecture For Machine to Machine Applications”, the entire contents of which are incorporated herein by this reference. The Applicant hereby claim the benefits of this earlier pending provisional application under 35 U.S.C. Section 119(e).

### FIELD OF THE RELATED ART

The present invention generally relates to systems and processes for monitoring and controlling devices that include a collection of sensors and actuators and services related thereto.

### BACKGROUND OF THE RELATED ART

As described throughout this disclosure, a machine generally refers to a hardware/software combination, the hardware comprising a computer, controller or micro-controller having at least a processor, memory, data busses and input/output (“I/O”). Generally, a first set of machines comprising at least one first machine, which are distal from a device, sensor or actuator may be referred to as a server(s) or the server side. Coupled to the I/O of at least one of such second set of machines is a device, sensor or actuator, such second set of machines comprising at least one second machine, and which may be referred to generically as a device, sensor or actuator, or the device side. Such second set of machines are generally adapted to, among other things, sense a condition or state, and/or control or actuate another device or mechanism, including but not limited to at least one valve, switch, relay, potentiometer, pump, seal, sensor, actuator and the like. While the hardware comprising the first and second set of machines may be hardwired to perform their activities, in the present invention, such hardware preferably has its physical states and characteristics defined by machine code which may be stored or embedded in memory and processed by the processor. The machine code derives from source code that is compiled. The machine code, the source code and programs from which it is derived, the protocols necessary to transmit and receive information, any applicable operating system and device drivers and the like, may be referred to generally as software, programs or application(s).

There exist a number of machine to machine (“M2M”) vertical applications, including but not limited to meter reading, vending machine monitoring, oil and gas well monitoring, industrial automation and remote servicing. Each of such vertical applications require custom program code both on the server side and on the device side in order to configure and enable the specific activities required by the vertical application.

Equipment in a wide range of industries is increasingly “smart,” with on-board intelligent devices that use embedded sensing and control to operate the equipment more effectively. These devices correlated to the equipment frequently has I/O that is adapted to transfer data serially for local configuration and diagnostics. Such equipment is “telemetry-ready,” which advantageously permits the devices to be coupled into an M2M solution comprising at least one server over a communication means.

With respect to the communications means, wireless carriers and radio module manufacturers have significantly reduced the cost of their components used in wireless telemetry applications. As used herein, communication means refers to the wired and wireless components and modules necessary to transmit and receive data between machines. Carriers have deployed new and improved wireless networking technologies that permit data to be carried much less expensively. Radio manufacturers have benefited from the component volumes and integration driven by the cellular handset industry to develop telemetry-oriented radio modems that are much less expensive.

Nevertheless, developing M2M applications that include a global network of devices, including sensors and actuators, is extremely complex and requires the custom programming of applications. The complexities of M2M applications include programming to integrate protocols at many layers. Further, each application must have customized server logic and device programming to accomplish its objectives. Disadvantageously, each vertical application is typically developed and maintained independently which can result in significant development and maintenance costs. One example of a conventional Behavior based architecture is AFSM (Augmented Finite State Machines) for robotics.

What is desired is a system and method that uses embedded and server intelligence to permit the development of custom applications for vertical use in the M2M context without the need for traditional or direct programming. Such a system and method would use a behavior based agent architecture for M2M communication using globally networked devices. What is also desired are business methods that permit the quick and inexpensive deployment of these applications in the M2M market.

### SUMMARY OF THE EXEMPLARY EMBODIMENTS

The present invention comprises a system and method that uses intelligence comprising a behavior based agent architecture at the server side and embedded at the device side that enables users to develop custom applications for vertical applications. Such a system and method quickly and inexpensively enables M2M communication using globally networked devices, sensors or actuators. The Behavior concept refers to the use of at least one stimulus-response pair. A self-contained message is an example of a stimulus (such as a telemetry reading, alarm and the like), for a Behavior created by a user, such as an end-user. If the Behavior resides on a server it is referred to as an “off-board” Behavior and if the Behavior resides on the device, it is referred to as “on device” Behavior. In an embodiment of the present invention, the application comprises a proxy representation and real onboard representation of Behaviors and agents.

### BRIEF DESCRIPTION OF THE DRAWINGS

FIG. 1 illustrates a block diagram of an M2M system of the present invention;

FIG. 2 illustrates a Behavior representation;

FIG. 3 illustrates a Behavior class diagram;

FIG. 4 is a screenshot of the Behavior Composer illustrating an entity selected and its available Behaviors;

FIG. 5 is a screenshot of a Behavior being created in the Behavior Composer; and

FIG. 6 is a screenshot of Behavior properties, “an actuator” being edited.

### DETAILED DESCRIPTION OF AN EXEMPLARY EMBODIMENT

M2M systems are typically comprised of several hardware and software components, including machines having hardware running an operating system and driver software, a wireless telemetry modem, communication service from a wireless network, general telemetry application software, and vertical application software. The many interfaces between these components are often not standardized, or may be poorly understood or documented.

The wireless link is an essential component of any remote telemetry application, but it is only a part of the overall system. A significant amount of engineering design, development and integration must occur around the wireless network to create a working telemetry application. As a result, application development and system integration is often cost prohibitive. For wireless links, the appropriate network technology must be selected to provide reliable coverage at the lowest cost. Once communications is accomplished, telemetry data is processed and retained in a way that is both organized and accessible. The telemetry system presents the data on demand, to users and applications, in formats that are meaningful and customized for each.

Building an end-to-end wireless M2M application requires selecting and integrating the correct components. This is a difficult, complex undertaking that requires technical mastery in several areas beyond the basic application itself. Few companies are able to afford to undertake such development and integration of the components despite the attractive return on investment.

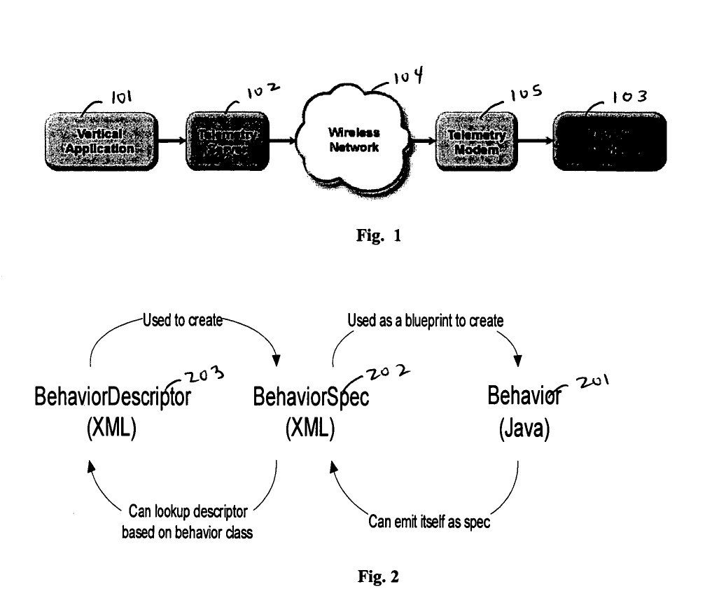

As seen generally in FIG. 1, the present invention comprises a pre-integrated application platform running a vertical application 101 that unifies the telemetry server 102 to the remote device 103 across a wireless network 104. The remote device 103 interfaces with the wireless network 104 through telemetry modem 105.

In one aspect, the present invention comprises an overall application and data communications architecture designed specifically for the unique requirements of M2M applications. In another aspect of the present invention, the design framework and highly functional platform of the present invention significantly reduces the development effort and difficulty required to create a remote telemetry application. The present invention enables telemetry applications having “off-the-shelf” characteristic allowing M2M solution developers the option to “buy” a complex part of the solution rather than having to design and build it themselves.

The architecture of the present invention is essentially the same, regardless of the specific vertical industries or remote equipment involved, as M2M applications are built as layers of capabilities. The foundation capabilities must be developed before higher layer functionality can be added. The functionality of one layer is built on and depends on the functionality of the layers below it.

The next level of M2M application functionality is the ability to analyze and interpret data to note events and exceptions with varying levels of significance. When appropriate, notifications of these events are sent automatically to applications on the server side and then to forwarded to recipients, if necessary, in forms that can be customized for each situation.

Whether automatically responding to telemetry data or to manual operator intervention, the next level of functionality of an M2M application is to adjust remote equipment settings to achieve performance targets. At its highest level of functionality, an M2M application automatically and continuously regulates the performance of multiple devices in an overall business operational process to minimize costs, maximize performance and achieve optimal profitability.

The platform of the present invention provides each of these functions in a generic, template form that an M2M application developer can configure to serve their specific application without having to do any programming. A Behavior based M2M platform is a combination of hardware and software that connects an active global network of devices that use Behavior composing, transmission and sequencing to avoid the need for direct programming.

Behaviors differ from rules as Behaviors comprises a stimulus response pair, not an IF/THEN statement. The response may consist of many IF/THEN statements and the Behavior may consist of many other Behaviors, in the case of a composite Behavior. A Behavior agent consists of the following: (1) a queue of stimuli to process; (2) a sequence of Behaviors; and (3) a logical thread of execution.

Referring to FIG. 2, Behaviors 201 serve as the basic building blocks for programming devices without requiring traditional or direct programming. Behaviors 201 can be created from a template or completely from scratch. A Behavior template combines the appropriate stimulus and reaction to create a “canned” Behavior easily; as opposed to creating a Behavior from scratch where it is up to the user to select the desired reaction to a specified stimulus. A Behavior 201 consists of two parts, the stimulus that initiates the Behavior and the reaction to the stimulus or the action.

BehaviorSpec 202 represents a specification that can be used to create a Behavior. It contains all the information that is needed such as UUID, Behavior settings, and Behavior class name. UUID refers to the Universally Unique Identifier and class name is the name of the actual class name that represents the Behavior. BehaviorDescriptor 203 represents a description of a BehaviorSpec 202 that is suitable for user manipulation. A BehaviorDescriptor 203 contains an ordered sequence PropertyDescriptors. These PropertyDescriptors form a sentence for the user to manipulate that directs the agent.

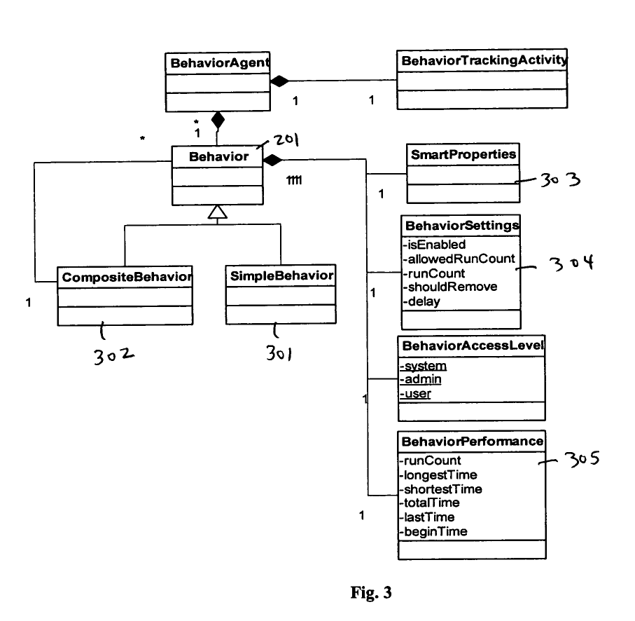

Referring now to the Behavior Class diagram of FIG. 3, SimpleBehavior 301 is comprised of a stimulus-reaction pair. CompositeBehavior 302 is a Behavior that is composed of other Behaviors—either Simple or Composite. A typical stimulus is a self contained message (such as a telemetry reading, alarm and the like) that contains all parameters or arguments needed. This self contained message corresponds to a class in the object-oriented programming sense. So, the Behavior can indicate what reaction occurs during a given stimulus class of message. SmartProperties 303 are a collection of named properties that have convenience methods to store and load the representation of the property. BehaviorSettings 304 represent the settings for a Behavior that includes whether the Behavior is enabled, the delay between reactions (default is 0 milliseconds), and an allowed number of times the Behavior can be exercised before it will automatically be disabled or removed. BehaviorPerformance 305 keeps track of, among other things, the shortest, longest, and average Behavior execution time (in milliseconds). A BehaviorAgent consists of a queue of stimuli to process; a sequence of Behaviors; and a logical thread of execution. BehaviorSequencing is the order that Behaviors are given a chance to respond to a stimulus. BehaviorInhibition is the ability for a single Behavior to inhibit Behaviors later in the sequence from getting a chance to respond to a stimulus. This gives a Behavior the ability to take control and to avoid other Behaviors from making conflicting control decisions. BehaviorPerformance 305 is recorded so that it can be accessed thru an InstrumentationRequest or viewed in a browser.

Behavior 201 is codified in the following general form:
when (Stimulus),
perform reaction

As used herein, the term “entity” refers to a group, device, sensor, or actuator. Each entity can have two representations, a first representation that runs on a centralized server, a proxy representation, and a second representation that can runs on the device. Certain Behaviors can exist in either location; or be transmitted wirelessly to the device. When transmitted to the device, the Behaviors can run without the need of further communication in order for the device to execute. In yet another aspect, Behaviors can be transmitted over a wired interface from the server side representation to a remote device so that device communicates less and can continue to process when communication cannot be established. Each entity has a logically separate thread of execution, so each entity can respond to stimuli independently of the other entities.

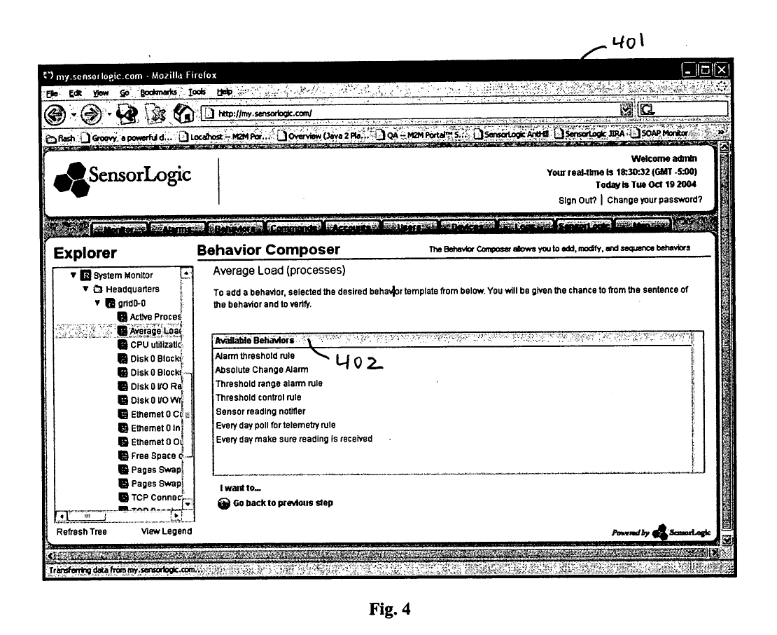

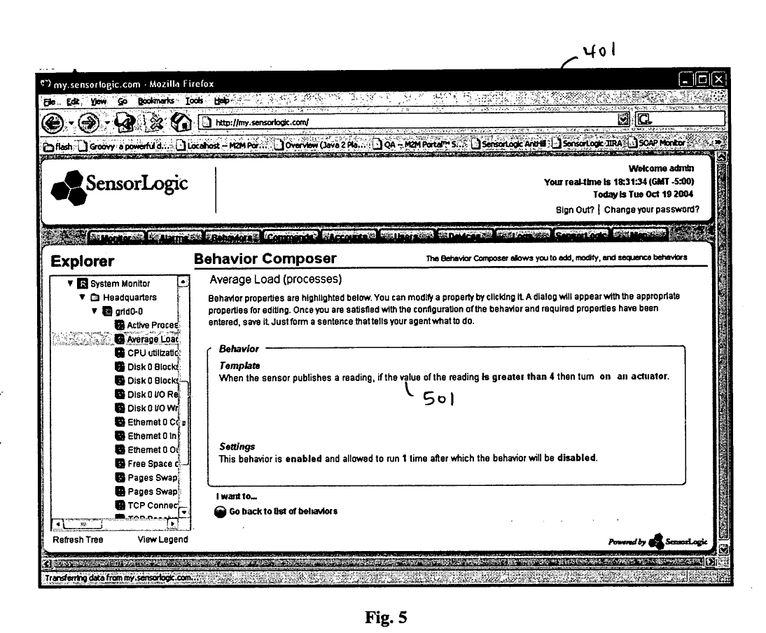

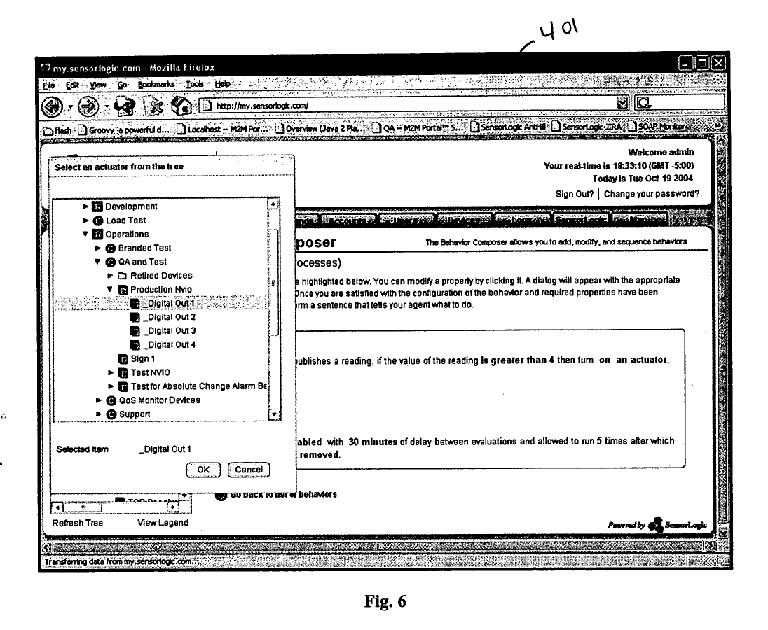

As seen in FIG. 4, the present invention is accessible to users through an M2M Portal. Access to the M2M Portal of the present invention is through a graphical user interface (“GUI”) referred to herein as the Behavior Composer 401. Entities are selected and Behaviors defined and assigned through this M2M Portal. FIG. 4 illustrates a selected entity with available Behaviors determined with classifier facts. As illustrated in FIGS. 4, 5 and 6 the sequence of events for avoiding direct programming of devices, sensors and actuators is as follows:
1. An entity is chosen such as a group of devices, or a single device in a graphical user interface.
2. A seen in FIG. 4, a Behavior is chosen from a list of available Behaviors 402. The list of available Behaviors is determined by the classifiers of the entity.
3. As seen in FIG. 5, once a Behavior is chosen, it is edited by completing the field of a sentence 501 where required properties are highlighted in a special color, such as red.
4. As seen in FIG. 6, optional properties can also be edited and other entities can be manipulated.
5. Once the user saves the Behavior it will either be transmitted to the centralized server representation (proxy) or transmitted to the device (if it is available as an “on device” Behavior and user directed to be on the device).
6. Thereafter, the Behavior will react anytime the appropriate stimulus is received by the entity.

The present invention enables several Behavior related actions or states: Behavior sequencing, Behavior inhibition; Behavior transmission; Behavior disablement; and Behavior settings. For example, once Behaviors are added, the Behavior Composer 401 allows the user to control the sequence of Behaviors, which comprises the order that the Behaviors are evaluated. This sequencing combined with the ability to inhibit Behaviors allows a user to add sophisticated logic and code to a device, sensor, or actuator without the need for direct or traditional programming. Behavior sequencing is the order that Behaviors are given a chance to respond to a stimulus. Behavior inhibition is the ability for a single Behavior to inhibit Behaviors later in the sequence from getting a chance to respond to a stimulus. This gives a Behavior the ability to take control and to avoid other Behaviors from making conflicting control decisions. Each entity has a separate thread of execution (logically), so each entity can respond to stimuli independently of the other entities. In addition, a Behavior may be disabled by the user or disabled by the Behavior itself. The advantage of disabling a Behavior is that it can be enabled at a later time without having to create the Behavior again. It can be enabled by a user or another Behavior. Finally, the Behavior Composer 401 allows Behaviors to be edited or removed after a Behavior has been created.

The present invention enables several novel business methods useful in a variety of vertical contexts. The M2M Portal comprises three major applications: an M2M application delivered over the web configured to provide data management and presentation for telemetry applications, a standardized, web-based front end for interfacing to a wireless carrier for data transport, provisioning and billing, and a “bill-on-behalf” service to create private labeled recurring invoices from application developer customers for invoicing end user customers. The M2M Portal can be an internet-based data management and communications platform in which a user (which may not be the end-user) can build a complete, end-to-end wireless telemetry solution. Such a communications platform would include basic telemetry functions, data collection and presentation capabilities, alarming and notification capabilities, control functions and a communications means through either a wireless or wire-line network by which M2M communication occurs.

All of the functionality of the M2M Portal is accessed through a web browser on any Internet connected personal computer. This permits access anytime and anywhere access with no software to install or internal IT support requirements. This M2M Portal solves complex problems common to all M2M applications and comes pre-built with powerful tools to configure operations for any vertical industry application. The M2M Portal provides an interface configured specifically for a specific user. The user can configure the specific M2M application with a number of options, including: naming and labels; data presentation and graphical display format; data collection frequency and method; data transformation and calibration; definition of exception conditions; alarm notification and processing; account organization and equipment management; and authentication & access control.

The M2M Portal platform handles all telemetry requirements from the wireless modem to the enterprise. With these telemetry capabilities, the M2M Portal enables application developers to quickly connect to their remote equipment, monitor, control, and optimize performance. The following functions are enabled: communication; data logging and storage; data analysis & display; alarming & notification; control and optimization. Fully integrated with voice capabilities, M2M Portal communicates alarms and notifications to any telephone number or Email address. A wide range of sensor values can be detected, including: analog values, digital values; text; image and location coordinates. Using actions common to PC-based applications, M2M Portal enables users to drag and drop graphics that create unique data displays, monitoring, and control panels.

The present invention is adapted to handle all of the data requirements from the modem to the enterprise. The present invention uses secure transport solutions over common carrier wireless technologies, including GSM/GPRS; SMS; CDMA 1X RTT; two-way paging; packet data; AMPS control channel; LEO satellite; GEO satellite; Internet and analog dial-in.

The present invention, as embodied by the M2M Portal, enables a managed service, allowing M2M solution developers to pay for the services they use, as they use them, which enables the developers to minimize their upfront investment and system maintenance costs. M2M application developers thus can “buy” an alternative to building an application and wireless communications interface, thereby reducing the time, cost and risk of M2M application development.

This novel service permits application developers to create integrated, end-to-end solutions efficiently and quickly. Such developers thus can address difficult and application specific challenges of integrating remote equipment with, for example, a wireless modem. Application developers can also configure the M2M Portal of the present invention for specific application and hardware configurations. While the M2M Portal must be configured to be aware of the remote hardware, the present invention does not provide hardware solutions. But application developers who design and integrate hardware solutions can use the novel service of the present invention as the “back end” platform for the rest of the end-to-end application solution.

Independent system integrators are enabled by the present invention to create specific vertical applications to be sold to other companies who will use the application in their business. The present invention is also adapted to be used by application developers who are equipment manufacturers or OEMs, who desire a telemetry-based information service for their products. Such a service can be an enhancement to sell to a customer, a product differentiator, or a mechanism for improving internal operations, such as preventive maintenance, or field service efficiency. The present invention is adapted to be used by application developers in end use companies who will deploy the application internally to provide their company a competitive advantage.

The service component of the present invention advantageously lowers the barriers to developing M2M solutions. In this way dedicated solution integrators, OEMs and end users can develop M2M systems quickly and easily in contrast to conventional methods in which significant technical capabilities and time resources are needed to build complex M2M systems.

The system and method of the present invention has several advantages over the conventional art. These include the ability to develop or customize M2M application without direct programming; ability to save communication costs if Behaviors are resident on the device as each reading does not have to be transmitted; ability to continue to operate even when communication is lost if Behaviors are resident on the device; reduction in the amount of sensor data needed to be sent remotely without programming; and it is not necessary to send code over wired interfaces.

The present invention enables a user to build an end-to-end remote telemetry system. Incorporated into this service model is a monthly billing service for those M2M application providers who do not already have such a system in place. The present invention also incorporates the functionality for managing accounts and invoicing for telemetry services. Such functionality includes an automated provisioning interface to wireless carriers. The present invention enables an application provider to privately label the M2M Portal, allowing it to monitor, control, activate, provision, and bill M2M services.

In a first embodiment of the service aspect of the present invention, the M2M Portal, system and method enables instrumentation manufacturers to charge its customers a service fee for the ability to remotely collect data on flow rates, pressures, temperatures, tank levels and equipment status using the M2M Portal, system and method as an alternative to manual, on-site data collection.

In a second embodiment of the service aspect of the present invention, the M2M Portal, system and method enables a manufacturer of injection pumps for producing wells to charge its customers a service fee for the ability of such customers using the M2M Portal, system and method to adjust the pump operation remotely in response to well and weather conditions as an alternative to on-site adjustment.

In a third embodiment of the service aspect of the present invention, the M2M Portal, system and method enables a manufacturer of machinery for preparing shipping packages to remotely monitor its equipment to detect failures, to schedule optimal preventive maintenance, and to track consumption of packaging chemicals as an alternative to manual inspection by its field service technicians or the customer's equipment operators.

In a fourth embodiment of the service aspect of the present invention, the M2M Portal, system and method enables a system integrator to retrofit department of transportation roadside signs with a means to remotely add federally emergency alerts and Amber Alerts to multiple signs at the same time as an alternative to manually programming signs on-site.

In a fifth embodiment of the service aspect of the present invention, the M2M Portal, system and method enables a manufacturer of telecommunications infrastructure equipment to charge a “pay-as-you-go” service fee for allowing its customers to remote configure and monitor smart antenna systems using the M2M Portal, system and method as an alternative to site visits by a customer field engineer.

In a sixth embodiment of the service aspect of the present invention, the M2M Portal, system and method enables a system integrator under a government contract to collect data from remote diagnostic equipment in a patient's home (i.e., blood pressure, weight, glucose level) as an alternative to the patient visiting a medical facility or a medical paraprofessional visiting the patient in the home.

In a seventh embodiment of the service aspect of the present invention, the M2M Portal, system and method enables a system integrator to use “on device” Behaviors and the M2M Portal to optimize efficiency of product that contains an embedded device that uses “on device” Behaviors and communication to the M2M Portal to continually optimize the sequence of Behaviors over the lifetime of the product; thus improving efficiencies over time and providing anticipated remote servicing.

In an eighth embodiment of the service aspect of the present invention, the M2M Portal, system and method enables a system integrator to use the M2M platform as a telematic application that includes exception handling, telemetry visualization, and event notification that enables dynamic changes based on geo-Behaviors.

n a ninth embodiment of the service aspect of the present invention, the M2M Portal, system and method enables a reseller to embed Behaviors to control fine grain entities in the home where “on device” Behaviors could provide intelligent control.

In a tenth embodiment of the service aspect of the present invention, the M2M Portal, system and method enables a series of mesh networks that use “on device” Behaviors to more intelligently manage traffic of sensors and ability to handle exceptions and escalations and environmental needs.

As can be seen, each remote telemetry application is different and addresses a specific vertical industry problem. The present application comprises a single platform to enable each of these telemetry applications. Components of this extendable development platform include an integrated rapid prototyping service that provides the GSM/GPS-enabled tools and application logic necessary to get a working solution up and running quickly. The M2M application development platform of the present invention enables developers to prototype, pilot and deploy full M2M applications across a range of vertical industries and applications.

Although an exemplary embodiment of the system and method of the present invention, and several exemplary embodiments of the services enabled by the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

1. A telemetry system, comprising:
at least one of a first set of machines;
at least one of a second set of machines;
a communication interface synchronously or asynchronously coupling said at least one of a first set of machines and at least one of said second set of machines;
a vertical application in communication with and among, said at least one from the first set of machines and at least one from the second set of machines; and
said vertical application having being developed using a behavior based agents architecture.

2. The system of claim 1, wherein the at least one of a first set of machines is a server side representation and the at least one of a second set of machines comprises a remote device.

3. The system of claim 2, wherein Behaviors are transmitted from the server side representation to a remote device; and
the device is adapted to execute if communication with the server side is interrupted.

4. The system of claim 3, wherein the representation of a Behavior is in XML or binary.

5. The system of claim 1, wherein each of the first set of machines and each of the second set of machines each comprise hardware configured by software.

6. The system of claim 5, wherein the hardware further comprises a computer, controller or micro-controller having at least a processor, memory, data busses and input/output (“I/O”).

7. The system of claim 5, wherein the remote device comprises at least one from the group of sensor and actuator.

8. The system of claim 7, wherein the at least one first machine is distal from the at least one second machine.

9. The system of claim 8, wherein each of such second set of machines is adapted to perform at least one activity from the following group of activities: sense a condition or state and control and actuate another device or mechanism.

10. The system of claim 9, wherein said another device or mechanism comprises at least one from the following group: valve, switch, relay, potentiometer, pump, seal, sensor, and actuator

11. The system of claim 10, wherein said at least one of a first set of machines and at least one of said second set of machines are used in a vertical application.

12. The system of claim 11, wherein said vertical application comprises one from the following groups of applications: meter reading, vending machine monitoring, oil and gas well monitoring, industrial automation and remote servicing.

13. The system of claim 1, wherein each of such first sets of machines and each of such second sets of machines are adapted to communicate over a communications interface.

14. The system of claim 13, wherein the communications interface comprises a wired interface.

15. The system of claim 14, wherein the communications interface is a wireless interface.

16. The system of claim 1, wherein the second set of machines further comprises a global network of devices.

17. The system of claim 1, wherein the second set of machines have embedded logic operable to enable the development of custom applications for vertical use.

18. A machine to machine telemetry development system, comprising:
server side hardware with a first wireless telemetry modem;
device side hardware with a second wireless telemetry modem;
a communications interface between the first and second wireless telemetry modem,
software adapted to configure the server side and device side hardware;
said software including an operating system, drivers and vertical application software; and
said vertical application software based in a behavior based agent architecture at the server side and embedded at the device side.

19. The system of claim 18, wherein the behavior based agent architecture can enable two active representations.

20. The system of claim 19, wherein the first representation runs on a centralized cluster of the server side, comprising a proxy representation and a second representation runs on the device.

21. The system of claim 19, wherein the representation of any Behavior can be in XML or binary.

22. The system of claim 18, wherein device eligibility is determined by the classification of the Behavior.

23. The system of claim 22, wherein certain Behaviors can exist at either the server side or device side.

24. The system of claim 22, wherein Behaviors that exist on the server side are transmitted wirelessly to the device.

25. The system of claim 24, wherein Behaviors existing on the device side can run without the need of further communication from the server side in order to execute.

26. The system of claim 22, wherein Behaviors are transmitted over a wired interface from the server side representation to a remote device enabling the device to communicate less and continue to process when communication cannot be established.

27. A platform for generating a plurality of vertical applications, said platform comprising a behavior based agent architecture.

28. The system of claim 27, wherein a plurality of functions can be composed from a generic, template form.

29. The system of claim 27, wherein the behavior based agent architecture of the vertical application enables the server side and device side to communicate in both directions.

30. The system of claim 27, wherein the platform enables a vertical application adapted to analyze and interpret data and note events and exceptions with varying levels of significance.

31. The system of claim 30, wherein notifications of these events are sent automatically to applications on the server side and then to forwarded to recipients, if necessary, in forms that can be customized for each situation.

32. The system of claim 27, wherein the platform is adapted to enable vertical applications to automatically respond to telemetry data or manual operator intervention.

33. The system of claim 27, wherein the platform enables a vertical application adapted to adjust remote equipment settings to achieve performance targets.

34. The system of claim 33, wherein the platform enables a vertical application adapted to automatically and continuously regulates the performance of multiple devices in an overall business operational process to minimize costs, maximize performance and achieve optimal profitability.

35. The system of claim 34, wherein the platform enables the development and configuration of a specific application without programming code.

36. The system of claim 35, wherein the platform uses Behavior composing, transmission and sequencing to avoid the need for direct programming in the development of vertical applications adapted to couple an active global network of devices.

37. The system of claim 36, wherein a Behavior comprises at least one stimulus-response pair.

38. The system of claim 37, wherein the stimulus comprises a self-contained message.

39. The system of claim 38, wherein the self contained message is a telemetry reading or alarm.

40. The system of claim 37, wherein a Behavior is created by an end user.

41. The system of claim 40, wherein a Behavior is a basic building block for programming devices without requiring traditional or direct programming.

42. The system of claim 41, wherein a Behavior is created from a template.

43. The system of claim 42, wherein the Behavior template combines the appropriate stimulus and reaction to create a “canned” Behavior.

44. A telemetry development platform delivered over a network configured to provide data management and presentation for telemetry applications, comprising:
a standardized, web-based front end for interfacing to a wireless carrier for data transport, provisioning and billing; and
a “bill-on-behalf” service to create private labeled recurring invoices from application developer customers for invoicing end user customers.

45. The platform of claim 44, wherein a user is enabled to develop a complete, end-to-end wireless telemetry solution without the need for direct code development.

46. The platform of claim 44, wherein such platform includes basic telemetry functions, data collection and presentation capabilities, alarming and notification capabilities, control functions and a communications interface for coupling a first machine and a second machine.

47. The platform if claim 44, adapted to enable a packaged managed service.

48. The platform of claim 47, wherein application developers are able to pay for the services as they are used.

49. The platform of claim 47, wherein developers are able to integrate remote equipment over a wireless interface.

50. The platform of claim 44, further comprising being used to create a vertical application to remotely collect data on flow rates, pressures, temperatures, tank levels and equipment status.

51. The platform of claim 44, further comprising being used to create a vertical application to adjust the pump operation remotely in response to well and weather conditions.

52. The platform of claim 44, further comprising being used to create a vertical application to remotely monitor equipment, detect failures, schedule optimal preventive maintenance, and track consumption of packaging chemicals.

53. The platform of claim 44, further comprising being used to create a vertical application used program signage used in emergency alerts and Amber Alerts.

54. The platform of claim 44, further comprising being used to create a vertical application to remotely configure and monitor smart antenna systems.

55. The platform of claim 44, further comprising being used to create a vertical application to remotely collect data from diagnostic equipment such as blood pressure, weight, and glucose level of a distal patient.

56. The platform of claim 44, further comprising an integrated rapid prototyping service.

57. The platform of claim 44, further comprising GSM/GPS-enabled tools and application logic.

58. A method of developing a machine to machine vertical application, comprising using a behavior based agent architecture at the server side and embedded at the device side.

59. The method of claim 58, wherein the behavior based agent architecture uses at least one stimulus-response pair.

60. The method of claim 59, wherein the Behavior resides on the device.

61. The method of claim 58, wherein the vertical application comprises a proxy representation and real onboard representation of Behaviors and agents.

62. A method for providing an architecture for machine to machine applications comprising behavior based agents.

63. A method of developing a vertical application among servers and devices using at least one Behavior, comprising:
choosing an entity from a group of devices;
choosing a Behavior from a list of available Behaviors as determined by the classifiers of the entity;
highlighting fields in a sentence that must be completed to assign Behavior to the entity;
editing the field of a sentence where required properties are highlighted; and
saving the Behavior.

64. The method of claim 63, further comprising transmitting the Behavior to at least one machine.

65. The method of claim 64, wherein the entity is chosen and Behavior is assigned in a graphical user interface (GUI);

66. The method of claim 64, wherein the Behavior is transmitted to a centralized server representation (proxy).

67. The method of claim 66, wherein the representation of any Behavior can be in XML or binary.

68. The method of claim 63, further comprising transmitting the Behavior to a device.

69. The method of claim 63, wherein the Behavior will react anytime the appropriate stimulus is received by the entity.

70. The method of claim 63, wherein each entity can have two representations, a first representation that runs on a centralized server, a proxy representation, and a second representation that can runs on the device.

71. The method of claim 63, wherein Behaviors that run on a device are adapted to run without the need of further communication from a server in order to execute.

72. The method of claim 63 further comprising the following Behavior related actions or states: Behavior sequencing, Behavior inhibition; Behavior transmission; Behavior disablement; and Behavior settings.

73. The method of claim 72, wherein the Behavior represents at least one stimulus-response pair.

74. The method of claim 73, wherein the stimulus comprises a self contained message that contains all parameters or arguments needed for the device

75. The method of claim 74, wherein the self contained message corresponds to a class in the object-oriented programming context.

76. The method of claim 75, wherein the Behavior can indicate what reaction occurs during a given stimulus class of message.

77. The method of claim 63, wherein the Behavior comprises a composite Behavior.

78. The method of claim 63, wherein a Behavior agent comprises a queue of stimuli to process, a sequence of Behaviors and a logical thread of execution.

79. The method of claim 63, wherein the Behavior comprises two parts, the stimulus that initiates the Behavior and the reaction to the stimulus or the action.

80. The method of claim 63, wherein the Behavior is codified in the following general form:
when (Stimulus),
perform reaction.

81. The method of claim 63, wherein the a simple Behavior comprises a Universally Unique Identifier; Classname, Smart Properties, BehaviorSetting and BehaviorPerformance.

82. The method of claim 81, wherein a BehaviorAgent comprises a queue of stimuli to process; a sequence of Behaviors; and a logical thread of execution;
Behavior Sequencing is the order that Behaviors are given a chance to respond to a stimulus;
Behavior Inhibition is the ability for a single Behavior to inhibit Behaviors later in the sequence from getting a chance to respond to a stimulus;
BehaviorPerformance is recorded so that it can be accessed thru an InstrumentationRequest or viewed in a browser;
BehaviorSpec represents a specification that can be used to create a Behavior. It contains all the information that is needed such as UUID, Behavior settings, and Behavior class name; and
BehaviorDescriptor represents a description of a BehaviorSpec that is suitable for user manipulation.

83. The method of claim 82, wherein a BehaviorDescriptor contains an ordered sequence PropertyDescriptors; and
PropertyDescriptors form a sentence for the user to manipulate that tells the agent what to do.

84. The method of claim 63, wherein each entity has a logically separate thread of execution, so each entity can respond to stimuli independently of the other entities.

85. The method of claim 63, wherein said method is performed on a development platform is delivered to users through a portal.

86. The method of claim 85, wherein said portal comprises a graphical user interface (GUI) to select, define and assign entities and Behaviors.

87. The method of claim 86, wherein such GUI allows the user to control the sequence of Behaviors, which comprises the order that the Behaviors are evaluated.

88. The method of claim 87, wherein such sequencing, coupled with the ability to inhibit Behaviors, enables a sophisticated logic and code to be added a device, sensor, or actuator without direct programming.

89. The method of claim 88, wherein Behavior sequencing is the order that Behaviors are given a chance to respond to a stimulus.

90. The method of claim 89, wherein Behavior inhibition is the ability for a single Behavior to inhibit later Behaviors in the sequence from responding to a stimulus.

91. The method of claim 90, wherein each entity has a separate thread of execution (logically), so each entity can respond to stimuli independently of the other entities.

92. The method of claim 87, wherein the GUI enables Behaviors to be edited or removed after a Behavior has been created.

93. The method of claim 87, wherein a Behavior may be disabled by a user or by the Behavior itself.

94. The method of claim 93, wherein a disabled Behavior can be enabled at a later time without having to create the Behavior again.

95. The method of claim 93, wherein a disabled Behavior can be enabled by a user or another Behavior.
